(19) United States
(12) Patent Application Publication
(10) Pub. No.: US 2012/0145949 A1
(43) Pub. Date: Jun. 14, 2012

(54) Method for producing electronic grade aqueous ammonium fluoride solution

(75) Inventors: Jiarong Zhan, Shanghai (CN); Li Zhou, Shanghai (CN)

(73) Assignee: SHANGAI HUAYI MICROELECTRONIC MATERIAL CO., LTD., Shanghai (CN)

(21) Appl. No.: 12/973,434

(22) Filed: Dec. 20, 2010

(30) Foreign Application Priority Data
Dec. 8, 2010 (CN) 201010577191.X

(51) Int. Cl. C09K 13/00

(52) U.S. Cl. 252/79.1

(57) ABSTRACT

The present invention relates to a method for producing of electronic grade aqueous ammonium fluoride solution. The industrial grade liquid ammonia is used as the raw material, when it is heated, the ammonia gas will be released. The organic gas impurities in the ammonia gas are removed by activated charcoal, and the oxygen is removed by deoxidizer, and then the high-purity ammonia gas is gotten. The high-purity hydrofluoric acid absorbs and reacts with the high-purity ammonia gas to obtain the electronic grade aqueous ammonium fluoride solution. The product has high-purity and stable quality, and it can be used in producing of electronic products directly. The method for producing of electronic grade ammonium aqueous fluoride solution provided by the present invention is suitable for continuous production on a large scale because of its simple operation.

### RELATED APPLICATIONS

The present application claims priority under 35 U.S.C. §119(b) to the Chinese Patent Application Serial No. 201010577191.X, filed Dec. 8, 2010, by Jiarong Zhang et al., the entire disclosure of which, including the drawings, is hereby incorporated by reference herein.

### FIELD OF THE INVENTION

The present invention relates to a method for producing of aqueous ammonium fluoride solution, and in particular to a method of simple operation for producing of electronic grade ammonium fluoride aqueous solution.

### BACKGROUND OF THE DISCLOSURE

Ammonium fluoride is widely used in process of electronic products because of its good feature in etching. With the rapid development of electronics industry, electronic grade ammonium fluoride demand is increasing; and higher purity of the ammonium fluoride is required.

The conventional method for producing of electronic grade ammonium fluoride is liquid phase method, i.e a hydrogen fluoride (HF) or hydrofluoric acid is reacted with ammonia solution or liquid ammonia, and the product is obtained by cooling the reactant to crystallization, centrifuge, and drying. This procedure has a long production cycle, labor-intensive operation, serious pollution, large consumption of energy for the treatment of mother liquor, and lots of metal ion impurities in the product. Chinese patent CN1955115A disclosed a process for preparing solid ammonium fluoride with hydrogen fluoride gas, ammonia gas and high-purity water to prepare ammonium fluoride solution, and then crystallization to get the product. That is a conventional method to produce electronic grade ammonium fluoride.

Chinese patent CN101671036A disclosed a process for preparing solid high-purity ammonium fluoride. The ammonium fluoride solution of 8 to 50% concentration is used as raw material to react with ammonia solution or liquid ammonia, and then with barium hydroxide and other reagents involved in the reaction. The ammonium fluoride solution is filtered and then crystallizes in vacuum and cryoconcentration condition. After drying, the high-purity ammonium fluoride is obtained. The above method, that is an improvement of conventional method, has long production cycle, multi-procedure, complex operation and high cost features.

So far, there have few reports about the method for producing of electric grade aqueous ammonium fluoride solution. The common method is to get the solid ammonium fluoride first, and then dissolve it in solution. Because of its strongly hygroscopic, the solid ammonium fluoride is polluted easily during storage, so the cost of storage is high and the product quality is instability. And there are lots of other faults in the above method for producing of solid ammonium fluoride. So, looking for an economical, feasible and convenient method for producing the electronic grade aqueous ammonium fluoride solution has important practical significance.

### SUMMARY OF THE INVENTION

Aiming at overcoming the problem, such as large consumption of energy, complex operation, instable product quality and biggish fluctuation of product purity, of the prior art about producing of electric grade aqueous ammonium fluoride solution, the present invention provides a method for producing of electric grade aqueous ammonium fluoride solution. The high purity ammonia gas is obtained by preliminary treating the ammonia gas, the high purity ammonia gas is absorbed by the high-purity hydrofluoric acid circularly, and the goal product is gained. Because of the preliminary treatment, the impurities in raw material are removed. Circularly absorption makes the heat which is generated in reaction eliminated rapidly. So the by-product is reduced. Therefore, the method has the advantages of simple operation and stable product quality, and overcomes the prior art's faults such as high impurity content in product and instability product quality.

The present invention, a method for producing of electric grade aqueous ammonium fluoride solution includes following steps:

Step 1: an industrial grade liquid ammonia is heated to 30˜50° C. and then an ammonia gas is released from the liquid ammonia, a high-purity ammonia gas is obtained by using activated charcoal to remove the organic gas impurities and deoxidizer to remove oxygen in the gaseous ammonia;

Step 2: a high-purity hydrofluoric acid absorbs and reacts with the high-purity ammonia gas to obtain the electronic grade aqueous ammonium fluoride solution.

Wherein, the activated charcoal can be powder activated charcoal. And its material can be woodiness (such as sawdust), or high quality coal.

Wherein, the optimized concentration of high-purity hydrofluoric acid solution is 40%˜55% and the optimized concentration of industrial grade liquid ammonia solution is 75%˜90%.

According to a preferred embodiment of the method for producing an electronic grade aqueous ammonium fluoride solution, wherein, the high-purity ammonia gas flows into the reactor from the top of the reactor, and high-purity hydrofluoric acid flows into the reactor from the bottom of the reactor, during the process of absorption of the high-purity ammonia gas by the high-purity hydrofluoric acid.

Preferred embodiment is that the process of the high-purity hydrofluoric acid absorbing the high-purity ammonia gas is circularly.

Wherein, the flow rate of the high-purity ammonia gas is controlled in the range of 10˜15 kg/h, when it flows into the reactor.

Preferred embodiment is that the high-purity ammonia gas passes through the activated charcoal under the pressure of 0.1˜0.15 MPa during the process of activated charcoal adsorption.

The containers' or pipelines' inwalls that touch the substance of industrial grade liquid ammonia, ammonia gas, high-purity ammonia gas, high-purity hydrofluoric acid and ammonium fluoride aqueous solution during the production are coated with the high-purity perfluorinated materials.

Wherein, the perfluorinated material refers to the polymer materials all of which hydrogen atoms attached to carbon atoms are replaced by fluorine atoms, such as, polyfluoroalkoxy(PFA), polytetrafluotoethylene tetrafluoroethylene-hexafluoropropylene copolymer and etc.

When the mass concentration of ammonium fluoride aqueous solution reached to 40˜55% that was measured in the exit of reactor, the reaction is stop.

By the method refer to in the present invention, the mass concentration of ammonium fluoride aqueous solution produced reaches 40˜55%, single metal ion impurity is less than 0.1 ppm, the solid particles which is bigger than 0.5 μm is less than 5 per ml.

Compared with the prior art, the present invention of a method for producing of electric grade aqueous ammonium fluoride solution has the following advantages:

First, it takes preliminary treatment procedure to remove the impurities in the raw material, avoiding the problem of excessive impurities and hard treatment.

Second, circularly absorption can make the heat generated in the reaction eliminated rapidly. So it reduces by-product and effectively improves product quality.

Third, the method of the present invention has simple operation, and no after-treatment is demanded. And the product can be directly used in the production of electronic products. Therefore, the production capacity is improved.

In conclusion, the ammonium fluoride aqueous solution by the method of the present invention has a stable product quality and a high purity. Moreover, the method of the present invention has simple operation and it is adapted for continuative production.

### BRIEF DESCRIPTION OF THE DRAWINGS

FIG. 1 illustrates the process of the method of the present invention, in which sign 1 is raw material tank of liquid ammonia; sign 2 is heated filter; sign 3 is activated charcoal absorber; sign 4 is oxygen absorber; sign 5 is reactor; sign 6 is inlet of high-purity hydrofluoric acid; sign 7 is product storage tank.

### DETAILED DESCRIPTION OF THE EMBODIMENTS

The present invention refers to a method for producing of electronic grade aqueous ammonium fluoride solution. An industrial grade liquid ammonia is used as raw material, when it is heated to 30˜50° C. the ammonia is released from the liquid ammonia. The organic gas impurities in gaseous ammonia are removed by activated charcoal and the oxygen is removed by deoxidizer, and then the high-purity ammonia gas is obtained. The high-purity hydrofluoric acid absorbs and reacts with the high-purity ammonia gas; and the product of the reaction is the electric grade aqueous ammonium fluoride solution.

Wherein, the concentration of high-purity hydrofluoric acid solution is 40%˜55% and the concentration of industrial grade liquid ammonia solution is 75%˜90%. In order to increase the rate of purification and keep the effect of purification, it can take the high-purity ammonia gas passing through activated charcoal under the pressure of 0.1˜0.15 MPa.

The high-purity hydrofluoric acid flows into the reactor from the bottom of the reactor, and absorbs the high-purity ammonia gas circularly. The high-purity ammonia gas flows into the reactor from the top of the reactor, at the flow rate of 10˜15 kg/h. It can make the heat which is generated in the reaction eliminated rapidly. So the by-product is reduced, and the method effectively improves product quality.

In the present invention, the containers' or pipelines' inner walls that touch the substance of industrial grade liquid ammonia, ammonia gas, high-purity ammonia gas, high-purity hydrofluoric acid and ammonium fluoride aqueous solution during the production, are coated with high-purity perfluorinated materials. It helps the above substances get away from pollution, to make the product in stable quality and to reduce the corrosion of containers' and pipelines' inwalls.

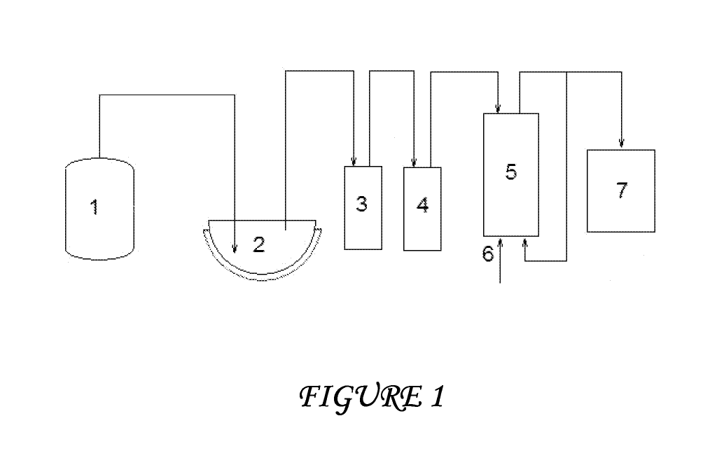

A better understanding of the present invention is obtained when the following non-limiting detailed description is considered in conjunction with FIG. 1.

### Embodiment 1

The industrial grade liquid ammonia of 75% which is in the raw material tank of liquid ammonia 1 is delivered into heated filter 2 and the industrial grade liquid ammonia is heated to 40° C., then the ammonia gas is released from the liquid ammonia. Under the pressure of 0.1 MPa, the ammonia gas passes through wooden power activated charcoal absorber 3 and oxygen absorber 4, the organic gas impurities and oxygen are removed.

The obtained high-purity ammonia flows into the reactor 5 from the top of the reactor 5 at the flow rate of 10 kg/h, and the high-purity hydrofluoric acid flows into the reactor from the bottom of the reactor 5. The 40% high-purity hydrofluoric acid absorbs the high-purity ammonia gas circularly. The reactor is cooled down by condensate water. The aqueous ammonium fluoride solution is collected when the testing data is accord with the standard data and is stored in product storage tank 7.

The assay of product is that: the concentration of high-purity hydrofluoric acid solution is 40%, and there is single metal ion impurity of 0.1 ppm and solid particles which is bigger than 0.5 μm of 4 per ml. More details are in Table 1.

### Embodiment 2

The implementation of the method is described with reference to Embodiment 1.

The industrial grade liquid ammonia of 80% is heated to 50° C. Under the pressure of 0.12 MPa, the ammonia gas passes through sawdust power activated charcoal absorber 3 and oxygen absorber 4, the organic gas impurities and oxygen are removed.

The obtained high-purity ammonia flows into the reactor 5 from the top of the reactor 5 at the flow rate of 13 kg/h, and the high-purity hydrofluoric acid flows into the reactor from the bottom of the reactor 5. The 50% high-purity hydrofluoric acid absorbs the high-purity ammonia gas circularly. The reactor is cooled down by condensate water. The aqueous ammonium fluoride solution is collected when testing data is accord with the standard data.

The assay of product is that: the concentration of high-purity hydrofluoric acid solution is 50%, and there is single metal ion impurity of 0.1 ppm and the solid particulates which is bigger than 0.5 μm of 3 per ml. More details are in Table 1.

### Embodiment 3

The implementation of the method is described with reference to Embodiment 1.

The industrial grade liquid ammonia of 90% is heated to 55° C. Under the pressure of 0.15 MPa, the ammonia gas passes through the high quality coal power activated charcoal absorber 3 and oxygen absorber 4, the organic gas impurities and oxygen are removed.

The obtained high-purity ammonia flows into the reactor 5 from the top of the reactor 5 at the flow rate of 510 kg/h, and the high-purity hydrofluoric acid flows into the reactor from the bottom of the reactor 5. The 55% high-purity hydrofluoric acid absorbs the high-purity ammonia gas circularly. The reactor is cooled down by condensate water. The aqueous ammonium fluoride solution is collected when testing data is accord with the standard data.

The assay of product is that: the concentration of high-purity hydrofluoric acid solution is 55%, and there is single metal ion impurity of 0.1 ppm and the solid particulates which is bigger than 0.5 μm of 3 per ml. More details are in Table 1.

TABLE 1
The test result of product in embodiment 1~3

| | | SEMI | | | |
|---|---|---|---|---|---|
| | | C1.3- | Embodi- | Embodi- | Embodi- |
| Item | U.M. | 95 | ment 1 | ment 2 | ment 3 |
| Color | APHA | 10 | 6 | 5 | 6 |
| pH | | 6.0~7.5 | 6.2 | 6.0 | 6.5 |
| (1% solution | | | | | |
| at 25° C.) | | | | | |
| Chloride | ppm | 4 | 2 | 2.5 | 2.5 |
| Nitrate | ppm | 10 | 3 | 4 | 4 |
| Phosphate | ppm | 1 | 0.5 | 0.3 | 0.6 |
| Sulfate | ppm | 2 | 1.2 | 0.9 | 1.0 |
| Aluminum | ppm | 0.2 | 0.1 | 0.1 | 0.1 |
| Antimony | ppm | — | — | — | — |
| Arsenic | ppm | — | — | — | — |
| Antimony | ppm | 0.03 | 0.01 | 0.01 | 0.02 |
| and Arsenic | | | | | |
| (as Arsenic) | | | | | |
| Barium | ppm | — | — | — | — |
| Beryllium | ppm | — | — | — | — |
| Bismuth | ppm | — | — | — | — |
| Boron | ppm | 0.2 | 0.15 | 0.1 | 0.1 |
| Cadmium | ppm | — | — | — | — |
| Calcium | ppm | 0.2 | 0.2 | 0.1 | 0.13 |
| Chromium | ppm | 0.1 | 0.1 | 0.09 | 0.06 |
| Cobalt | ppm | — | — | — | — |
| Copper | ppm | 0.1 | 0.08 | 0.08 | 1.0 |
| Gallium | ppm | — | — | — | — |
| Germanium | ppm | — | — | — | — |
| Gold | ppm | 0.3 | 0.2 | 0.2 | 0.2 |
| Indium | ppm | — | — | — | — |
| Iron | ppm | 0.2 | 0.2 | 0.15 | 0.16 |
| Lead | ppm | 0.3 | 0.2 | 0.25 | 0.25 |
| Lithium | ppm | — | — | — | — |
| Magnesium | ppm | 0.2 | 0.1 | 0.1 | 0.1 |
| Manganese | ppm | 0.2 | 0.1 | 0.1 | 0.1 |
| Molybdenum | ppm | — | — | — | — |
| Nickel | ppm | 0.3 | 0.25 | 0.2 | 0.2 |
| Platinum | ppm | — | — | — | — |
| Potassium | ppm | 0.3 | 0.2 | 0.18 | 0.2 |
| Silicon | ppm | — | — | — | — |
| Silver | ppm | — | — | — | — |
| Sodium | ppm | 0.3 | 0.22 | 0.2 | 0.2 |
| Strontium | ppm | — | — | — | — |
| Thallium | ppm | — | — | — | — |
| Tin | ppm | 0.2 | 0.2 | 0.15 | 0.18 |
| Titanium | ppm | 0.3 | 0.2 | 0.2 | 0.2 |
| Vanadium | ppm | — | — | — | — |
| Zinc | ppm | 0.2 | 0.18 | 0.15 | 0.16 |
| Zirconium | ppm | — | — | — | — |
| >1.0 μm | per ml | 10 | — | — | — |
| particles | | | | | |
| >0.5 μm | per ml | — | 4 | 3 | 3 |
| particles | | | | | |

According to data in Table 1, the conclusion that the pure of aqueous ammonium fluoride solution obtained by the present invention is up to the standard of SEMI C1.3-95 (Grade 1) is obtained. The ammonium aqueous fluoride solution produced can be used in the process of electronic products polishing.

It will be appreciated that the description of the embodiments above is only the illustrations of application, and doesn't limit the invention to the specific embodiments illustrated. Numerous other ways of carrying out the method provided by the present invention may be devised by a person skilled in the art without departing from the scope of the invention, and are thus encompassed by the present invention. So that it should be understood that any identical shifting or modifying can be done without departing from the spirit and the scope of the present invention.

What is claimed is:

1. A method for producing of electronic grade aqueous ammonium fluoride solution characterized in that the method includes following steps:
an industrial grade liquid ammonia is heated to 30˜50° C. and then an ammonia gas is released from the liquid ammonia, a high-purity ammonia gas is obtained by using activated charcoal to remove the organic gas impurities and deoxidizer to remove oxygen in the gaseous ammonia;
a high-purity hydrofluoric acid absorbs and reacts with the high-purity ammonia gas to obtain electronic grade aqueous ammonium fluoride solution.

2. A method according to claim 1 characterized in that the activated charcoal is wooden powder activated charcoal or high quality coal power activated charcoal.

3. A method according to claim 1 characterized in that the high-purity ammonia gas flows into the reactor from the top of the reactor and the high-purity hydrofluoric acid flows into the reactor from the bottom of the reactor during the process of absorption of the high-purity ammonia gas by the high-purity hydrofluoric acid.

4. A method according to claim 3 characterized in that the high-purity hydrofluoric acid absorbs the high-purity ammonia gas circularly.

5. A method according to claim 4 characterized in that the flow rate of the high-purity ammonia gas is controlled in the range of 10˜15 kg/h when it flows into the reactor.

6. A method according to claim 1 characterized in that the concentration of the high-purity hydrofluoric acid solution is 40%˜55%.

7. A method according to claim 1 characterized in that the concentration of the industrial grade liquid ammonia solution is 75%˜90%.

8. A method according to claim 1 characterized in that the high-purity ammonia gas passes through activated charcoal under the pressure of 0.1˜0.15 MPa during the process of activated charcoal adsorption.

9. A method according to claim 1 characterized in that the containers' or pipelines' inner walls, that touch the substance of the industrial grade liquid ammonia, ammonia gas, high-purity ammonia gas, high-purity hydrofluoric acid and ammonium fluoride aqueous solution during the production, are coated with the high-purity perfluorinated materials.
